(19) United States
(12) Patent Application Publication
(10) Pub. No.: US 2012/0160812 A1
(43) Pub. Date: Jun. 28, 2012

(54) METHOD FOR SEALING VAPOR CHAMBER

(75) Inventors: DE-YU WANG, Shenzhen City (CN); JIANG-JUN HU, Shenzhen City (CN); QING-PING YAN, Shenzhen City (CN)

(73) Assignees: FOXCONN TECHNOLOGY CO., LTD., Tu-Cheng (TW); FU ZHUN PRECISION INDUSTRY (SHEN ZHEN) CO., LTD., Shenzhen City (CN)

(21) Appl. No.: 13/189,577

(22) Filed: Jul. 25, 2011

(30) Foreign Application Priority Data
Dec. 25, 2010 (CN) 201010605218.1

(51) Int. Cl. B23K 9/038

(52) U.S. Cl. 219/78.16

(57) ABSTRACT

An exemplary method for sealing a vapor chamber includes, firstly, providing a casing, wherein the casing has an opening. Then a metallic tube is inserted into the opening such that the tube is hermetically engaged in the opening. Next, a pressing mold is provided, wherein the pressing mold includes a positive pole and a negative pole opposite to the positive pole. A free end of the tube is pressed by the positive pole and the negative pole of the pressing mold to form a crimped sealing portion. Then electricity is charged between the positive pole and the negative pole. The electricity passes through the crimped sealing portion and heats an inner face of the crimped sealing portion to weld the crimped sealing portion.

### BACKGROUND

1. Technical Field

The present disclosure relates to a method for sealing a vapor chamber used in electronic devices.

2. Description of Related Art

Vapor chambers have excellent heat transfer performance due to their low thermal resistance, and are therefore an effective means for transferring or dissipating heat from heat sources in electronic devices. Currently, vapor chambers are widely used for removing heat from heat-generating components such as central processing units (CPUs) of computers.

A vapor chamber is usually a vacuum casing containing a working fluid therein. It is necessary for the vapor chamber to be hermetically sealed after being vacuum-exhausted, thus forming a sealed structure. However, during the sealing process, air at the outside of the vapor chamber may leak into the vapor chamber and re-pressurize the vapor chamber. When this happens, once the vapor chamber is installed in (e.g.) a computer, it is difficult for the working fluid to evaporate and for the vapor chamber to operate properly.

Therefore, it is desirable to provide a method for sealing a vapor chamber which can overcome the limitations described above.

### BRIEF DESCRIPTION OF THE DRAWINGS

Many aspects of the present method can be better understood with reference to the following drawings. The components in the drawings are not necessarily drawn to scale, the emphasis instead being placed upon clearly illustrating the principles of the present method. Moreover, in the drawings, like reference numerals designate corresponding parts throughout the several views.

FIG. 1 is an isometric view of a vapor chamber and two poles of a pressing mold, showing an initial stage of a process for sealing the vapor chamber in accordance with a first embodiment of the present disclosure.

FIG. 2 is an enlarged end view of part of FIG. 1, showing two poles of a pressing mold ready to press an elongated tube of the vapor chamber.

FIG. 3 is similar to FIG. 2, but showing a subsequent stage of the process for sealing the vapor chamber in accordance with the first embodiment of the present disclosure.

FIG. 4 is an isometric view of part of a vapor chamber sealed by a process in accordance with a second embodiment of the present disclosure.

FIG. 5 is an isometric view of a vapor chamber sealed by a process in accordance with a third embodiment of the present disclosure.

FIG. 6 is an enlarged view of a circled part VI of FIG. 5.

### DETAILED DESCRIPTION

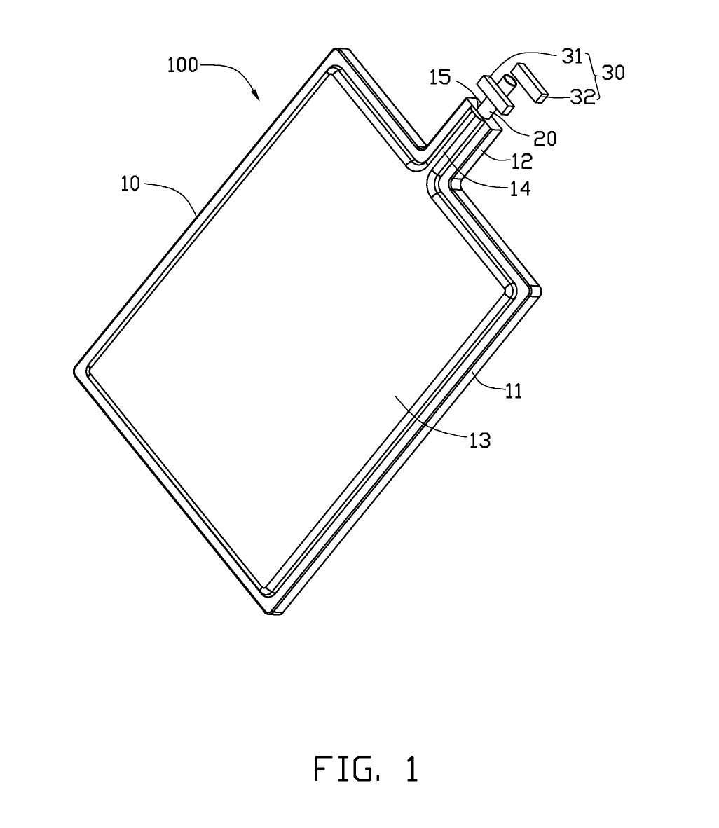

Referring to FIGS. 1-3, a process for sealing a vapor chamber 100 in accordance with a first embodiment of the present disclosure is as follows:

Firstly, a flat casing 10 is provided, as shown in FIG. 1. The casing 10 is made of highly thermally conductive material such as copper or aluminum. The casing 10 is a rectangular hollow plate, and accommodates a working medium or fluid (not shown) therein. The working medium is usually selected from a liquid which has a relatively low boiling point, such as water, methanol, or alcohol. A wick structure (not shown) is formed in the casing 10. The casing 10 comprises a rectangular base 11, an elongated first protruding portion 12 integrally extending outwardly from the base 11, a rectangular cover 13 hermetically covering the base 11, and an elongated second protruding portion 14 integrally extending outwardly from the cover 13. The cover 13 has a profile corresponding to the base 11. The second protruding portion 14 has a profile corresponding to the first protruding portion 12. The second protruding portion 14 hermetically covers the first protruding portion 12. The casing 10 defines an opening portion 15. In this embodiment, the opening portion 15 is cooperatively formed by free ends of the first protruding portion 12 and the second protruding portion 14. An inner space of the opening portion 15 is communicated with an inner space of the casing 10.

An elongated tube 20 is provided, also as shown in FIG. 1. An end of the tube 20 is inserted into the opening portion 15 of the casing 10, whereby the inner space of the casing 10 is communicated with an outer environment of the vapor chamber 100 only via the tube 20. In this embodiment, an outer wall of the tube 20 is hermetically sealed in the opening portion 15. The tube 20 is made of electrically conductive metal, such as copper.

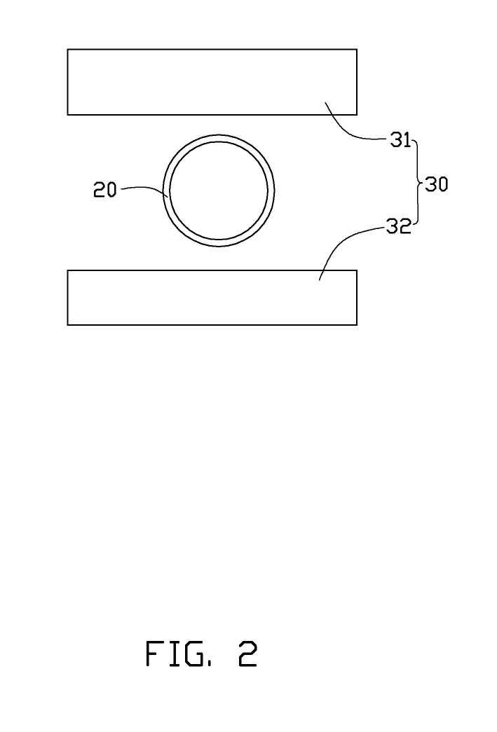

Referring also to FIG. 2, a pressing mold 30 is provided. The pressing mold 30 comprises a positive pole 31 and a negative pole 32 respectively arranged at opposite sides of the tube 20. The positive/negative poles 31/32 are in the form of dies, and are electrically conductive. A conductance of the positive/negative poles 31/32 is smaller than that of the tube 20.

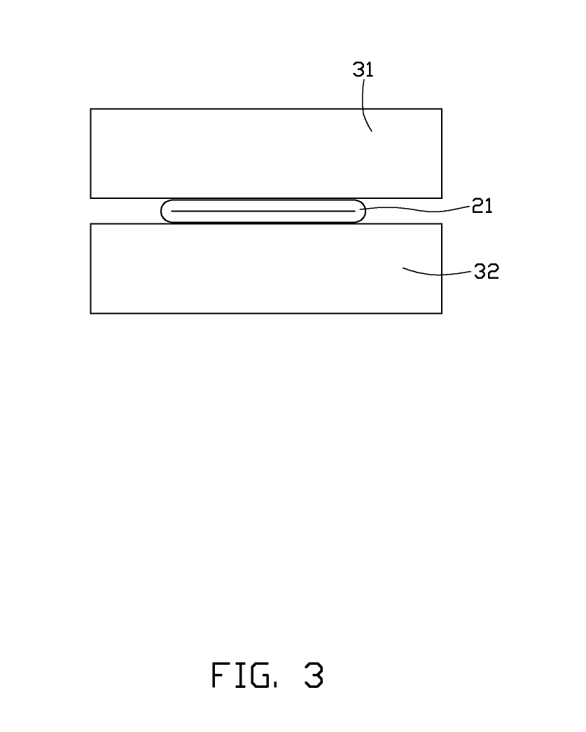

Referring also to FIG. 3, a free end of the tube 20 is pressed by the positive pole 31 and the negative pole 32 of the pressing mold 30 to form a crimped sealing portion 21. After pressing and retaining the positions of the positive pole 31 and the negative pole 32 in their pressing positions as shown in FIG. 3, the positive pole 31 and the negative pole 32 are charged with electricity. A value of a voltage applied between the positive pole 31 and the negative pole 32 is preferably 220 volts. Since the tube 20 is electrically conductive, the electricity passes through the crimped sealing portion 21 and heats the inner faces of the crimped sealing portion 21 to a melted state, whereby the inner faces are welded together. Thereby, the crimped sealing portion 21 is hermetically sealed, and the sealed casing 10 is obtained.

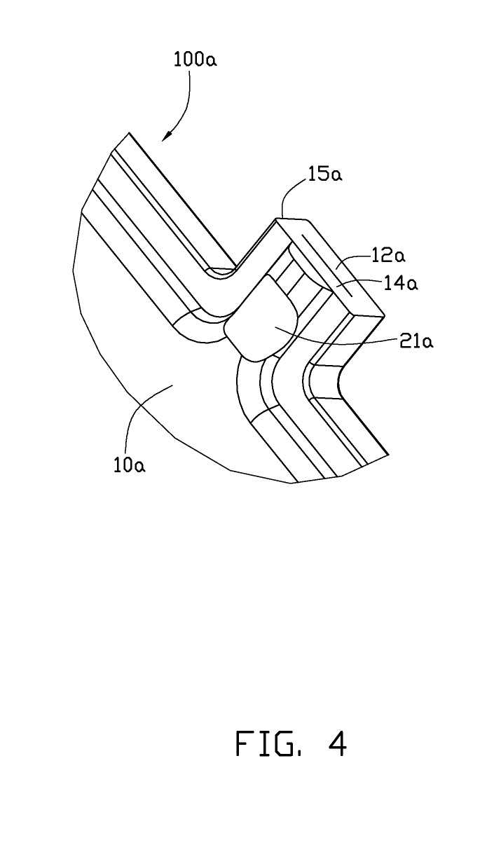

Referring to FIG. 4, part of a vapor chamber 100a sealed in accordance with a method of a second embodiment of the present disclosure is shown. In this embodiment, a flat casing 10a is similar to the casing 10 described above in relation to the first embodiment. A first protruding portion 12a and a second protruding portion 14a of the casing 10a cooperatively form an opening portion 15a. The opening portion 15a is pressed by the positive pole 31 and the negative pole 32 of the pressing mold 30 to form a crimped sealing portion 21a. A conductance of the positive/negative poles 31/32 is smaller than that of the crimped sealing portion 21a. Electricity is generated between the positive pole 31 and the negative pole 32. The electricity passes through the crimped sealing portion 21a, and heats inner faces of the crimped sealing portion 21a to a melted state, whereby the inner faces are welded together. Thereby, the crimped sealing portion 21a is hermetically sealed, and the sealed casing 10a is obtained.

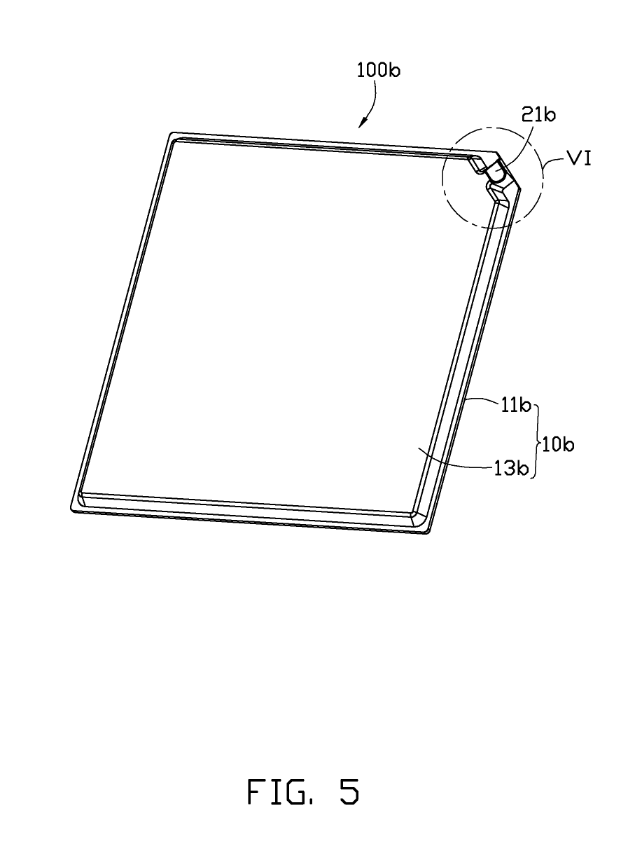

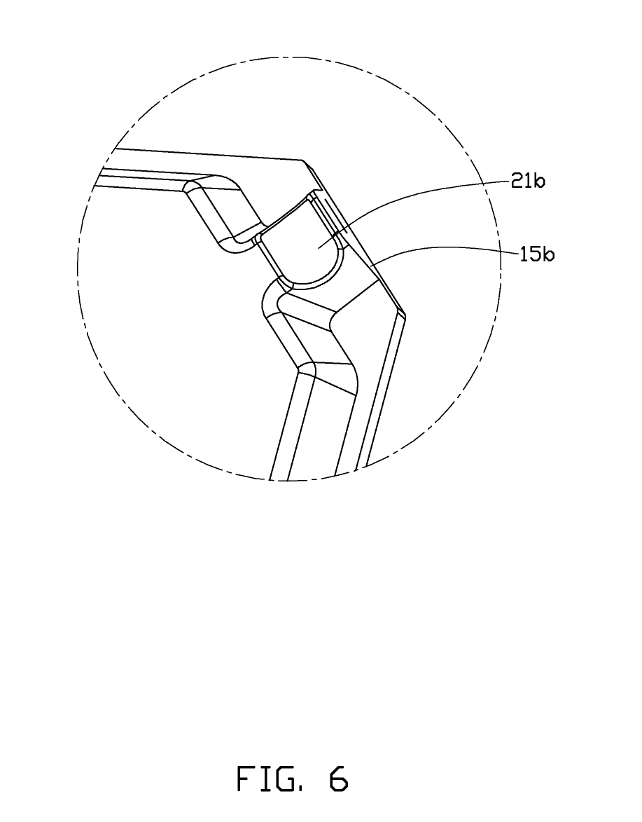

Referring to FIGS. 5-6 also, aspects of a vapor chamber 100b sealed in accordance with a method of a third embodiment of the present disclosure are shown. In this embodiment, a flat casing 10b is similar to the casing 10 described above in relation to the first embodiment. The casing 10b comprises a rectangular base 11b, and a rectangular cover 13b hermetically covering the base 11b. The casing 10b defines an opening portion 15b at a corner thereof. In this embodiment, the opening portion 15b is cooperatively formed by corresponding corners of the base 11b and the cover 13b. The opening portion 15b of the casing 10b is pressed by the positive pole 31 and the negative pole 32 of the pressing mold 30 to form a crimped sealing portion 21b. Because the casing 10b is electrically conductive, when electricity is generated between the positive pole 31 and the negative pole 32, the electricity passes through the crimped sealing portion 21b. The electricity heats the crimped sealing portion 21b to a partly melted state, whereby inner faces of the crimped sealing portion 21b are welded together. Thereby, the crimped sealing portion 21b is hermetically sealed, and the sealed casing 10b is obtained.

It is to be understood, however, that even though numerous characteristics and advantages of the present invention have been set forth in the foregoing description, together with details of the structures, functions and processes of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for sealing an opening portion of a casing to form a sealed vapor chamber, the method comprising:
providing a pressing mold, the pressing mold comprising a positive pole and a negative pole opposite to the positive pole;
pressing the opening portion of the casing by the positive pole and the negative pole of the pressing mold to form a crimped sealing portion; and
charging electricity between the positive pole and the negative pole, the electricity passing through the crimped sealing portion and generating heat at an inner face of the crimped sealing portion to melt and weld the crimped sealing portion, thereby forming the sealed vapor chamber.

2. The method of claim 1, wherein an electrical conductance of the positive pole is lower than that of the crimped sealing portion.

3. The method of claim 1, wherein an electrical conductance of the negative pole is lower than that of the crimped sealing portion.

4. The method of claim 1, wherein the crimped sealing portion is made of copper.

5. The method of claim 1, wherein the casing comprises a base, a first protruding portion extending outwardly from the base, a cover hermetically covering the base, and a second protruding portion extending outwardly from the cover.

6. The method of claim 5, wherein the second protruding portion hermetically covers the first protruding portion.

7. The method of claim 6, wherein the opening portion is formed between the first protruding portion and the second protruding portion.

8. The method of claim 1, wherein the casing comprises a base, and a cover hermetically covering the base.

9. The method of claim 8, wherein the opening portion is formed between the base and the cover.

10. A method for sealing a vapor chamber, the method comprising:
providing a casing, the casing having an opening portion;
providing a metallic tube, and inserting the tube into the opening portion such that the tube is hermetically engaged in the opening portion;
providing a pressing mold, the pressing mold comprising a positive pole and a negative pole opposite to the positive pole;
pressing a free end of the tube by the positive pole and the negative pole of the pressing mold to form a crimped sealing portion; and
charging electricity between the positive pole and the negative pole, the electricity passing through the crimped sealing portion and heating an inner face of the crimped sealing portion to weld the crimped sealing portion.

11. The method of claim 10, wherein the tube is communicated with an inner space of the casing.

12. The method of claim 10, wherein an electrical conductance of the positive pole is lower than that of the tube.

13. The method of claim 10, wherein an electrical conductance of the negative pole is lower than that of the tube.

14. The method of claim 10, wherein the tube is copper.

15. The method of claim 10, wherein the casing comprises a base, a first protruding portion extending outwardly from the base, a cover hermetically covering the base, and a second protruding portion extending outwardly from the cover, the second protruding portion hermetically covering the first protruding portion.

16. The method of claim 15, wherein the opening portion is defined between the first protruding portion and the second protruding portion.

17. A method for sealing a vapor chamber, the method comprising:
providing a casing;
inserting a metallic tube into the casing, the tube communicating with an inner space of the casing and protruding out from the casing;
providing a pressing mold, the pressing mold comprising a positive pole and a negative pole opposite to the positive pole;
pressing an opening end of the protruding part of the tube by the positive pole and the negative pole of the pressing mold to form a crimped sealing portion; and
charging electricity between the positive pole and the negative pole, the electricity passing through the crimped sealing portion and heating an inner face of the crimped sealing portion to weld the crimped sealing portion.

18. The method of claim 17, wherein the casing comprises a base, a first protruding portion extending outwardly from the base, a cover hermetically covering the base, and a second protruding portion extending outwardly from the cover, the second protruding portion hermetically covering the first protruding portion.

19. The method of claim 18, wherein the tube is inserted between the first protruding portion and the second protruding portion.

20. The method of claim 17, wherein an electrical conductance of the negative pole and the positive pole is lower than that of the tube.
